(19) United States
(12) Patent Application Publication
(10) Pub. No.: US 2004/0255874 A1
(43) Pub. Date: Dec. 23, 2004

(54) Method and system for increasing fuel economy in carbon-based fuel combustion processes

(76) Inventors: James Haskew, Joplin, MO (US); Thomas Matthew Bair, Colorado Springs, CO (US)

Correspondence Address: SCHMEISER OLSEN & WATTS, 18 E UNIVERSITY DRIVE, SUITE # 101, MESA, AZ, 85201

(21) Appl. No.: 10/825,000

(22) Filed: Apr. 14, 2004

Related U.S. Application Data
(60) Provisional application No. 60/463,159, filed on Apr. 14, 2003.

(51) Int. Cl. F02M 1/00

(52) U.S. Cl. 123/1 A

(57) ABSTRACT

Method for reducing pollution emissions and increasing fuel economy for carbon-based combustion processes. Embodiments of the invention comprise combinations of an airborne catalyst blend with various fuel and/or oil filters to produce unexpected efficiency results. A full system includes a fuel purifier, a microfine fuel filter, and/or a bypass oil filter in combination with an airborne catalyst blend dispenser or a catalyst/fuel mixture. Methods of filtering fuel and/or oil prior to burning fuel in the presence of an airborne catalyst blend also improve fuel economy and reduce pollution emissions for carbon-based combustion processes.

The present invention claims priority to U.S. Provisional Patent Application 60/463,159 to Haskew, et al., filed Apr. 14, 2003 and titled “Method and System for Increasing Fuel Economy in Carbon-Based Fuel Combustion Processes”, the disclosure of which is hereby incorporated herein by reference.

### BACKGROUND OF THE INVENTION

1. Technical Field

This invention generally relates to a method and system for improving the fuel economy or combustion efficiency of and reducing air pollution emissions from the burning of carbon-based fuels in engines, controlled flame processes and burners.

2. State of the Art

For years engine manufacturers have attempted to overcome inevitability of fuel contamination and poor maintenance. These shortcomings were marginally addressed in many engines still operating today. With the addition of exhaust emission controls, internal engine contamination has increased exponentially. To attempt to address all system deficiencies simultaneously along with environmental variables, the industry has offered options of finer filtration. To provide consistent exhaust emissions, however, the finer filtration systems increase the dependence of the engine upon consistent maintenance of the filtration systems to maintain fuel and oil system performance. If the systems with the finer filtration components added are poorly maintained, the system as a whole deteriorates more rapidly than standard systems. Additionally, fuel quality has diminished considerably over the last 12 years, thereby multiplying the effect of fuel and oil system contamination.

Fuel and oil filtration is presently not considered a pollution reduction process by the industry. This position by the industry is in part because the industry, including the fuel and oil filter manufacturers themselves, has not been able to yet produce adequate reduction in pollution emissions to be recognized as effective. Additionally, standard laboratory tests to determine the effectiveness of fuel and oil filtration do not generally involve use of contaminated fuel or oil. The California Air Resources Board (“CARB”) does not even recognize technologies yielding pollution particulate reductions below 25 percent or of NOx reductions less than 15 percent. Therefore, unless the fuel or oil is dramatically and in most cases fatally contaminated, filtration using conventional systems will not achieve, and to date has not yet achieved, recognition by CARB. In fact, in some cases, filtration has actually resulted in an increase in some reduction targeted emissions.

CARB states that exhaust emission reductions less than 10 percent are statistically of no effect. As a result, many companies not in compliance with pollution regulations are required to pay significant government fines for not being in compliance, and many companies are required to expend significant funds routinely upgrading equipment and maintaining equipment to get into or remain in compliance.

It is desirable to both the filter manufacturer industry and the pollution control industry to have a fuel and/or oil filter system that results in significant and recognizable reductions in pollution and particulates without the expensive and high maintenance solutions currently on the market.

### DISCLOSURE OF THE INVENTION

The system and principles discussed herein are applicable to internal combustion engines or compression applications, burner or non-compression and/or negative compression applications, as well as other combustion process applications that will be clear to those of ordinary skill in the art from the disclosure provided herein. The system combines multiple existing and previously unassociated products into a single system. Prior to the present combination, experts in the fuel combustion art did not seriously look at the use of filters as a pollution reduction tool because the fuel and oil available on the market are so inconsistent that the emissions control results in tests were unreliable. Specific embodiments of the present invention address fuel and engine condition inconsistencies to produce reliable and repeatable exhaust emissions and fuel consumption reductions in actual operating conditions. Embodiments of the present invention overcome the fuel and engine condition inconsistencies, improve fuel economy and reduce air pollution emissions from carbon-based fuel combustion processes.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a combustion efficiency improvement system configured according to an embodiment of the present invention.

### DETAILED DESCRIPTION OF EMBODIMENTS OF THE INVENTION

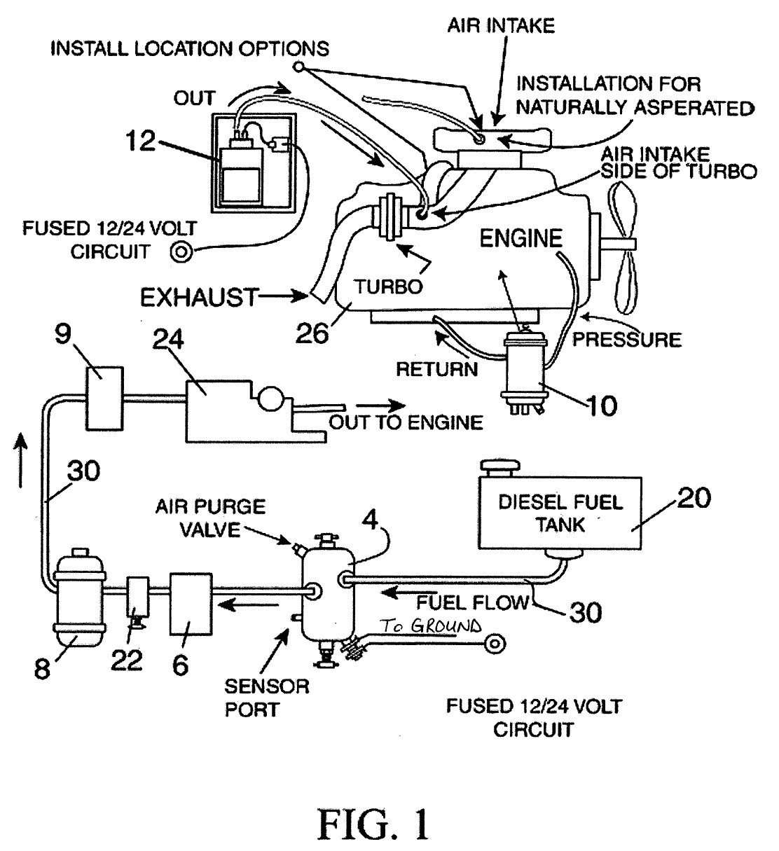

The attached FIG. 1 is an illustrative example of an embodiment of a fuel efficiency system 2 for a diesel engine employing many components, not all of which are required for improved fuel combustion processes, reduced pollution and efficiency. In embodiments of the system where less than all of the components are employed, the system shown in FIG. 1 would be modified by merely removing the component from the drawing and attaching the relevant fluid line to the next section in the flow line. Those of ordinary skill in the art will understand this process and the advantages and disadvantages of doing this for each particular embodiment from the disclosure provided herein.

Embodiments of the present invention consist of a kit for including into an engine either during original manufacture of the engine or as a retrofit option to existing engines. The kit includes a fuel filter such as a fuel purifier 4, a microfine fuel filtration component 8 or both, a bypass oil filtration component 10, and an airborne combustion catalyst 12 or oxidation enhancer. The combustion catalyst may consist of an airborne catalyst or an airborne catalyst blend (multiple catalysts delivered simultaneously for various functions during combustion and exhaust) induced into the intake air stream or a combustion catalyst, oxidation enhancer, and/or catalyst blend introduced through the fuel system.

Examples of the combustion catalyst and related distribution system, including a complete explanation of its operation and make-up, is disclosed in U.S. Patent Application Publication Number 20020165088, entitled “CATALYST COMPOSITION AND METHOD FOR OXIDIZING MIXTURES,” and U.S. Patent Application Publication Number 20020150514, entitled “DELIVERY SYSTEM FOR LIQUID CATALYSTS”, the disclosures of which are hereby incorporated herein by reference. Other examples of combustion catalysts and distribution systems are disclosed in U.S. Pat. No. 4,295,816, entitled “CATALYST DELIVERY SYSTEM”, and U.S. Pat. Nos. 6,176,701 and 6,419,477, entitled “METHOD FOR IMPROVING FUEL EFFICIENCY IN COMBUSTION CHAMBERS.”

Other components shown in FIG. 1, such as a diesel fuel tank 20, primary and secondary fuel filters 6 and 9, fuel transfer pump 22 and fuel injection pump 24, and the various components of the Engine 26, such as the air intake, exhaust, turbo, and the like, are components common to engines known in the art and are not novel or unique to the present invention. Additionally, some of the system components 4, 8, 10 and 12, may be coupled to the engine components in other locations than are shown in FIG. 1 where access to particular fuel lines or engine lines are difficult to reach. Those of ordinary skill in the art will understand how and where these components may be coupled from the knowledge available in the prior art in light of the disclosure provided herein.

Embodiments of the present invention may be used with the combustion of liquid or gaseous carbon-based fuels. Although some of the embodiments shown and described herein are described with reference to a vehicle engine because of the particular need for this invention in the vehicle engine pollution control industry, embodiments of the invention may similarly be applied to many types of carbon-based fuel engines with similar results.

The advantages of filtration and water separation to liquid fuels as well as gaseous fuels will be clear from the disclosure provided herein. The processes disclosed herein may be applied not only to petroleum based fuels, but also to pollution reduction and combustion efficiency in the use of alternative fuels or fuel blends such as: biodiesel, fuel emulsifications, and many other well known alternative or alternate fuels.

The embodiment of the invention comprising the full system described herein with reference to FIG. 1 has been tested and proven both on the dynamometer and in the field to improve fuel economy up to and in excess of 10 percent, and to reduce nitrous oxide emissions by greater than 20 percent, CO emissions by greater than 25 percent, hydrocarbon emissions by greater than 25 percent and particulate emissions by greater than 25 percent as compared to the same combustion process without the system shown in FIG. 1 of the present invention. As with any emissions control system, results very depending use. The various embodiments of the invention provide a reduced effect on the environment and on component deterioration related to conventional fuel and exhaust emissions efficiency.

Examples and Descriptions of the Various System Components:

The examples and descriptions of the various system components provided herein are provided as examples only. It will be understood by those of ordinary skill in the art that there are a number of components on the market that may be substituted in the place of each of the components described here. Substitution of components may achieve greater or lesser results from the results experienced in previous testing using these components.

Fuel Purifier 4: A fuel purifier separates water from the fuel and filters particulates from the fuel. While there are many fuel purifiers available on the market, two examples of acceptable purifiers are part number RC 400-E supplied by RCI Technologies of San Dimas, Calif., U.S.A. and part number ADF-10 supplied by Dahl. Other versions and part numbers are also equally acceptable.

Microfine Fuel Filter 8: A microfine fuel filter provides additional fuel filtering to capture particulates and contaminants in the fuel to a level much smaller than the primary fuel filter of the process. Microfine filtration is defined as any filter whose filtration media filters to 5 micron or less. Depth-type microfine fuel filters are generally the longest lasting and most reliable microfine filters. However, any filter of 5 micron or less would suffice for use with embodiments of the invention. While any additional level of filtering is beneficial to the process, two examples of acceptable fuel filters are part number F2 supplied by Gulf Coast Filters of Gulfport, Miss., U.S.A., and part numbers 900385 (housing) and 0672 (element) supplied by Harvard Corporation of Evansville, Wis., U.S.A. The Harvard Corporation filters are also protected by U.S. Pat. Nos. 4,792,397, 4,780,204, and 5,270,668, the disclosures of which are hereby incorporated herein by reference. Other versions and part numbers are also equally acceptable.

Bypass Oil Filter 10: A bypass (depth-type) oil filter provides additional oil filtering to capture particulates and contaminants in the oil to a level much smaller than a conventional oil filter. While any additional level of filtering is beneficial to the process, two examples of acceptable bypass oil filters are part number O2 supplied by Gulf Coast Filters, and part numbers 90060 (housing) and 0682 (element) supplied by Harvard Corporation. Microfine oil filtration (5 micron or less) would also be possible substitutes for the depth oil filtration because of the level of filtering provided. Other versions and part numbers are also equally acceptable.

Airborne Catalyst Blend 12: An airborne catalyst blend such as those described earlier provide enhanced burning characteristics for carbon-based combustion processes. Examples of acceptable catalyst blends are those supplied by Combustion Catalyst Industries of Colorado, associated with the inventor of the present invention. Other airborne catalyst blends are also equally acceptable.

Voltage Spike or Transient Voltage Suppressor (not in FIG. 1): Although it would not be practical in the embodiment shown in FIG. 1, in certain cases an additional voltage spike or transient voltage suppressor may be used on a power generator for additional fuel savings. Where electricity is used in large amounts with a combustion process, such as with a generator, use of a voltage suppressor to regulate the voltage levels supplied can result in electricity savings. An example of an acceptable voltage suppressor is “Redi/olt” part number 3 (270/480 3 or 4 wire) supplied by Ener/Tech of Hammond, La., U.S.A. Other versions and part numbers are also equally acceptable.

Description of Exemplary Embodiments and Combinations

The embodiments of the present invention described below involve various advantageous combinations of the respective components of the system for use simultaneously as a kit. Use of these various combinations described below has displayed repeatable efficiency and pollution reduction results in diesel, gasoline and bunker engines. Given the consistency of performance and results, it is anticipated that these results are also achievable in non-compression or negative compression environments as well; especially those burning liquid fuel.

Reference is made in each of these embodiments to the components of FIG. 1. Those of ordinary skill in the art will understand from the description herein that where particular system components shown in FIG. 1 are not referenced in the combination, those components are either components in a standard engine or are system components not used for that combination. With regard to the connectivity of FIG. 1, the fuel lines would simply bypass those components of the drawing in connecting the combination.

Combination 1: This combination integrates a microfine fuel filter 8 with an airborne catalyst blend 12. The microfine fuel filter 8 is a full flow filter that attaches within the engine fuel feed line 30 on the pressure side of the transfer pump 22 possibly between the primary 6 and secondary 9 filters. In the case of large engines, the primary 6 and secondary 9 filters may filter the fuel directly out of the storage tanks. The microfine fuel filter conventionally improves fuel consistency by removing primarily a majority of non-combustibles and secondarily some large hydrocarbons (agglomerated asphaltines) from the fuel. Due to inconsistencies (uncleanliness) in conventional fuel available for supply, the conventional process that involves a microfine fuel filter delivers greatly inconsistent results.

A system that combines use of a microfine fuel filter 8 and the use of an airborne catalyst blend 12 was found to result in a previously unexpected and synergistic effect on combustion efficiency. The combined system better controls the fuel supply variables and improves fuel consistency and the overall performance of the combustion process when compared with a system using either component separately, or even compared with the additive benefits of each used separately.

A number of tests were performed on a Nordic Industries Caterpillar V-12 generator engine using two airborne catalyst units on one turbo engine. A baseline was established under normal operating conditions at 90% load using the engine's standard configuration. Opacity was measured at 100% and was measured both visually and by video camera. The engine used a base-line of 23.37 gallons of fuel per hour.

The engine was then run using a Combustion Catalyst Industries (“CCr”) airborne catalyst dispenser. After 230 hours of test operation, the engine used only 21.62 gallons of fuel per hour (resulting in approximately 13% better fuel economy than without the CCI dispenser) and a reduction in visible opacity of about 50%. The further addition of a microfine fuel filtration system resulted in an additional 32% reduction in the visible opacity of the emissions from the engine. This reduction is much higher than the less than 20% experienced by prior systems. This unexpected and synergistic relationship between the airborne catalyst system and the microfine fuel filter systems enables a filtration system to be considered as a pollution control device and to be used for meaningful pollution control where it was not previously possible.

One of the reasons the additional 32% reduction in opacity is so significant is that as the amount of pollution approaches zero, each percentage point becomes more difficult to obtain. This 32% is in addition to the 50% reduction experienced by the CCl unit alone. Conventionally, the addition of 30% biodiesel fuel mixed with 70% CA#2 diesel fuel results in less than a 20% reduction in particulates. Combined with the airborne catalyst unit and a microfine fuel filtration unit, the tests showed a particulate reduction in excess of 64 percent. Given these synergistic and unexpected results from the use of microfine fuel filtration in combination with an airborne catalyst unit, it is expected that other combinations of filtering systems with catalyst fuel components will yield similar synergistic effects and results.

Combination 2: This combination integrates a fuel purifier 4 with an airborne catalyst blend 12. The fuel purifier 4 component of the system connects to the engine fuel feed line 30 between the fuel tank 20 and the primary fuel filter 6. The airborne catalyst blend 12 delivers the airborne catalyst directly into the engine 26 intake air stream (either suction or pressure side). The effect on combustion efficiency from a fuel purifier 4 alone is minimal unless the fuel is consistently extremely dirty or laden with water. Accordingly, a system with a fuel purifier 4 alone, which is the conventional method, will do very little to reduce pollution or increase combustion efficiency and, therefore, is not reliable as a pollution reduction system.

A system that combines use of a fuel purifier 4 and the use of an airborne catalyst blend 12 results in a previously unexpected and synergistic effect on combustion efficiency. The combined system better controls the fuel supply variables and improves fuel consistency and the overall performance of the combustion process when compared with a system using either component separately, or even compared with the additive benefits of each component used separately.

Combination 3: This combination integrates a bypass oil filter 10 with an airborne catalyst blend 12. The bypass oil filter 10 removes contaminants in the oil (both non-combustibles and heavy or cracked hydrocarbons) through a bypass system. A conventional bypass system taps the oil pressure supply where a small amount of oil is continuously filtered and returned to the sump. Use of a bypass oil filter alone can reduce exhaust emissions, but not consistently and, therefore, is not reliable as a pollution reduction system. The effects of using a bypass oil filter alone vary between different engine makes or types. This inconsistency is derived from variations in fueling and in the case of engines, methods of sealing or delivering the lube oil, engine life or accumulated hours, and quality or quantity of maintenance.

A system that combines use of a bypass (depth) oil filter 10 and the use of an airborne catalyst blend 12 results in a previously unexpected and synergistic effect on combustion efficiency. The bypass oil filtering 10 enhances the performance of the airborne catalyst blend 12 by reducing oil-related contaminants within the combustion or flame zone. The resulting combustion process is significantly more efficient and consistent when compared with a system using either component separately, or even compared with the additive benefits of each used separately.

Combination 4: This combination integrates a fuel purifier 4, a microfine fuel filter 8 and an airborne catalyst blend 12. In this combination, the fuel purifier 4 improves the performance and longevity of the fuel filter 8, which improves the performance and consistency of the airborne catalyst blend 12. A system that combines use of a fuel purifier 4 and a microfine fuel filter 8 with the use of an airborne catalyst blend 12 results in a previously unexpected and synergistic effect on combustion efficiency. The combined system better controls the fuel supply variables, improves fuel consistency, improves the longevity of the related systems, and significantly improves the overall performance of the combustion process when compared with systems using the components separately, or even compared with the additive benefits of each used separately or pairs of the three used in combination.

Combination 5: This combination integrates a microfine fuel filter 8, a bypass oil filter 10 and an airborne catalyst blend 12. This combination reduces combustion contamination from both the fuel and from the oil. The fuel filter 8 controls the consistency of the fuel, and the oil filter 10 reduces oil related combustion contaminants. When combined with an airborne catalyst blend 12, pollution and efficiency performance was found to be significantly enhanced. A system that combines use of a microfine fuel filter 8 and a bypass oil filter 10 with the use of an airborne catalyst blend 12 results in a previously unexpected and synergistic effect on combustion efficiency. The combined system better controls the fuel and oil supply variables, improves fuel and oil consistency, improves the longevity of the related systems, and significantly improves the overall performance of the combustion process when compared with systems using the components separately, or even compared with the additive benefits of each used separately or pairs of the three used in combination.

Combination 6: This combination integrates a fuel purifier 4, a microfine fuel filter 8, a bypass oil filter 10, and an airborne catalyst blend 12. As expected from the results in the remainder of this disclosure, it was found that use of each of the filtering and purifying components of the system in combination yielded more consistent and clean oil and fuel to the combustion process. This, in turn, resulted in the airborne catalyst blend 12 performing much better than without the additional filtering and purifying. A system that combines use of a fuel purifier 4, a microfine fuel filter 8 and a bypass oil filter 10 with the use of an airborne catalyst blend 12 results in a previously unexpected and synergistic effect on combustion efficiency. The combined system better controls the fuel and oil supply variables, improves fuel and oil consistency, improves the longevity of the related systems, and significantly improves the overall performance of the combustion process when compared with systems using the components separately, or even compared with the additive benefits of each used separately or groups of the four used in combination.

Combination 7: This combination integrates all of the system components from Combination 6 for the burning of carbon-based fuels with a voltage suppressor coupled to the voltage supply to reduce total site pollution and/or improve economic operation where large use of electricity is employed. Use of a voltage suppressor with the system components from the embodiment of Combination 6 can reduce electric consumption and/or cost by 20% when compared with a conventional system without the voltage suppressor. It is expected that the voltage suppressor may also be used with each of the other combinations with improved results over use of the system without a voltage suppressor in the case of generators and electric motors in enclosed areas where electric motor and/or generator heat affects performance of engines within their proximity.

Conventional approaches to pollution reduction involved external filtering of exhausts, catalytic converters, cat traps and particulate traps. Embodiments of the present invention embody a unique and novel approach to combustion efficiency and pollution reduction not employed previously in carbon fuel combustion processes. By applying existing fuel and/or oil filtering components in a unique combination with an airborne catalyst dispenser or other fuel/catalyst mix, the combinations are able to achieve combustion efficiency and pollution reduction results beyond that which the individual components can perform.

The combination of these systems would obviously assist each other in overall emissions reductions and possibly fuel savings but the combinations outcomes far exceeded expectations and certainly not obvious to anyone skilled in the art. Filtration has never been considered a proactive resource to reduce pollution it has always been a reactive protective instrument for improving engine or burner longevity. Again with the synergistic relationship and the novel idea of utilizing filtration as a proactive and counter active measure to achieve consistent pollution results. Again a novel idea of economical pollution reduction also increasing the age-old use of extended longevity while providing unmatched pollution and fuel consumption reductions.

Methods of Improving Fuel Combustion Efficiency and Reducing Pollution

Embodiments of the invention also involve a method of controlling pollution, reducing pollution emissions, and increasing fuel efficiency of a carbon-based fuel-burning engine. The methods involve, as related to the combinations addressed above, 1) drawing fuel from a fuel tank associated with the engine and filtering the fuel as is conventionally done with an engine's fuel filter; 2) filtering the fuel, in addition to the conventional filtering, with a microfine fuel filter, a fuel purifier filter or both prior to pumping the fuel to the engine; and 3) burning a portion of the fuel in the engine in the presence of one or more catalysts. The catalysts may be airborne catalysts or catalysts that are mixed with the fuel prior entering the fuel tank or while they are in the fuel tank. Additionally, or alternatively, the fuel filtering may be removed and oil filtering using a bypass oil filter, either depth-type oil filtering or microfine oil filtering, or the oil filtering may be done in addition to the fuel filtering. Additionally, a voltage suppressor may be coupled to the engine voltage supply to reduce total site pollution and/or improve economic operation where large use of electricity is employed.

The various embodiments of this invention address pollution and fuel efficiency issues simultaneously by incorporating a process that chemically enhances combustion while controlling environmental variables with various components. The synergistic combination becomes complementary as fuel and/or oil contamination can add to pollution or exhaust emission quantities. The filtration used in various embodiments of the present invention reduces the pollution load, thereby allowing the combustion enhancer to work with increasing effectiveness as these filtration systems are added. Each component has a specific role within the kit, yet each filtration component multiplies the catalyst performance so that the combustion enhancer can overcome emissions increases while overall performance is improved.

Fuel savings is also enhanced by the coupling of these components both individually and collectively. The fuel purifier provides large particulate and water separation from the fuel thus reducing potential mechanical disturbances within the fuel system that decrease atomization and secondary fuel filter performance resulting in fuel consumption increases and greater exhaust emissions. Microfine fuel filtration provides a better filtration of the fuel and results in improved combustion enhancer performance except when faced with massive fuel contamination with water. Use of a fuel purifier in conventional systems can prevent water contamination up-stream but as a result ceases to flow fuel. Thus, the purifier and microfine filtration used in combination in embodiments of the present invention are complementary and produce additional performance for the combustion enhancer. Microfine oil filtration provides additional combustion chamber contamination protection, thus adding to the benefit of the fuel system purifier and to the effectiveness of the combustion enhancer.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A pollution control kit for use in reducing pollution emissions from a vehicle engine, the pollution control kit comprising:
an airborne catalyst dispenser configured for installation into the vehicle engine to dispense at least one airborne catalyst into an intake air stream of the vehicle engine; and
a fuel filter configured to couple to a fuel line of the vehicle engine between a fuel tank supplying fuel to the vehicle engine and the vehicle engine.

2. The pollution control kit of claim 1, wherein the fuel filter is a fuel purifier configured to separate water from the fuel and to filter particulates from the fuel.

3. The pollution control kit of claim 2, further comprising a microfine fuel filter configured to couple to the fuel line of the vehicle engine between the fuel purifier and the vehicle engine.

4. The pollution control kit of claim 3, further comprising a bypass oil filter configured to couple to the vehicle engine such that the bypass oil filter receives oil from the engine, filters contaminants from the engine oil, and returns the filtered oil to the engine.

5. The pollution control kit of claim 4, wherein the bypass oil filter is one of a depth-type bypass oil filter and a microfine bypass oil filter.

6. The pollution control kit of claim 1, wherein the fuel filter is a microfine fuel filter configured to remove particulates from the fuel that are less than or equal to about 5 microns in size.

7. The pollution control kit of claim 6, further comprising a bypass oil filter configured to couple to the vehicle engine such that the bypass oil filter receives oil from the engine, filters contaminants from the engine oil, and returns the filtered oil to the engine.

8. The pollution control kit of claim 7, wherein the bypass oil filter is one of a depth-type bypass oil filter and a microfine bypass oil filter.

9. The pollution control kit of claim 1, further comprising a bypass oil filter configured to couple to the vehicle engine such that the bypass oil filter receives oil from the engine, filters contaminants from the engine oil, and returns the filtered oil to the engine.

10. The pollution control kit of claim 9, wherein the bypass oil filter is one of a depth-type bypass oil filter and a microfine bypass oil filter.

11. A pollution control kit for use in reducing pollution emissions from a vehicle engine, the pollution control kit comprising:
an airborne catalyst dispenser configured for installation into the vehicle engine to dispense at least one airborne catalyst into an intake air stream of the vehicle engine;
a bypass oil filter configured to couple to the vehicle engine such that the bypass oil filter receives oil from the engine, filters contaminants from the engine oil, and returns the filtered oil to the engine.

12. The pollution control kit of claim 11, wherein the bypass oil filter is one of a depth-type bypass oil filter and a microfine bypass oil filter.

13. A method of controlling pollution by reducing pollution emissions from a vehicle engine, the method comprising:
drawing fuel from a fuel tank of the vehicle engine and filtering the fuel with a fuel filter of the vehicle;
filtering the fuel, in addition to filtering the fuel with the fuel filter of the vehicle, with at least one of a microfine fuel filter and a fuel purifier filter prior to pumping the fuel to the engine; and
burning a portion of the fuel in the engine in the presence of at least one airborne catalyst supplied to the engine by an airborne catalyst dispenser.

14. The method of claim 13, wherein filtering the fuel with at least one of a microfine fuel filter and a fuel purifier filter comprises filtering the fuel with both the microfine fuel filter and the fuel purifier filter.

15. The method of claim 14, further comprising filtering contaminants from oil from the vehicle engine with a bypass oil filter and returning the filtered oil to the engine while burning the fuel in the engine.

16. The method of claim 13, wherein filtering the fuel is done with the microfine fuel filter, the method further comprising filtering contaminants from oil from the vehicle engine with a bypass oil filter and returning the filtered oil to the engine while burning the fuel in the engine.

17. The method of claim 16, wherein the bypass oil filter is one of a depth-type bypass oil filter and a microfine bypass oil filter.

18. The method of claim 13, wherein filtering the fuel is done with the fuel purifier filter, the method further comprising filtering contaminants from oil from the vehicle engine with a bypass oil filter and returning the filtered oil to the engine while burning the fuel in the engine.

19. The method of claim 18, wherein the bypass oil filter is one of a depth-type bypass oil filter and a microfine bypass oil filter.

20. The method of claim 13, further comprising suppressing at least one of transient and spiking voltage with a voltage suppressor.
